(19) United States
(12) Patent Application Publication
(10) Pub. No.: US 2005/0262081 A1
(43) Pub. Date: Nov. 24, 2005

(54) System, method and computer program product for organization and annotation of related information

(76) Inventor: Ronald L. Newman, Bozeman, MT (US)

Correspondence Address: Erwin J. Basinski;Basinski & Associates, 113 San Nicolas Avenue, Santa Barbara, CA, 93109, US

(21) Appl. No.: 10/848,989

(22) Filed: May 19, 2004

(51) Int. Cl. G06F 7/00

(52) U.S. Cl. 707/9

(57) ABSTRACT

A method for collaboratively capturing and displaying relationships and associations between information or function in a visual “map”, for example a map consisting of text or graphic icons linked to Internet locations and displayed as connected or disconnected nodes in a graph. Arbitrary relationships between nodes may be collectively defined by users, allowing completely free-form arrangements, for example hierarchical, non-hierarchical, or circular, or consisting of one or more disconnected sub-graphs. Annotations may be attached both to nodes and to the relationship connections between nodes. Input of new data to a map is facilitated by means of an intelligent data-gathering button and automated form management.

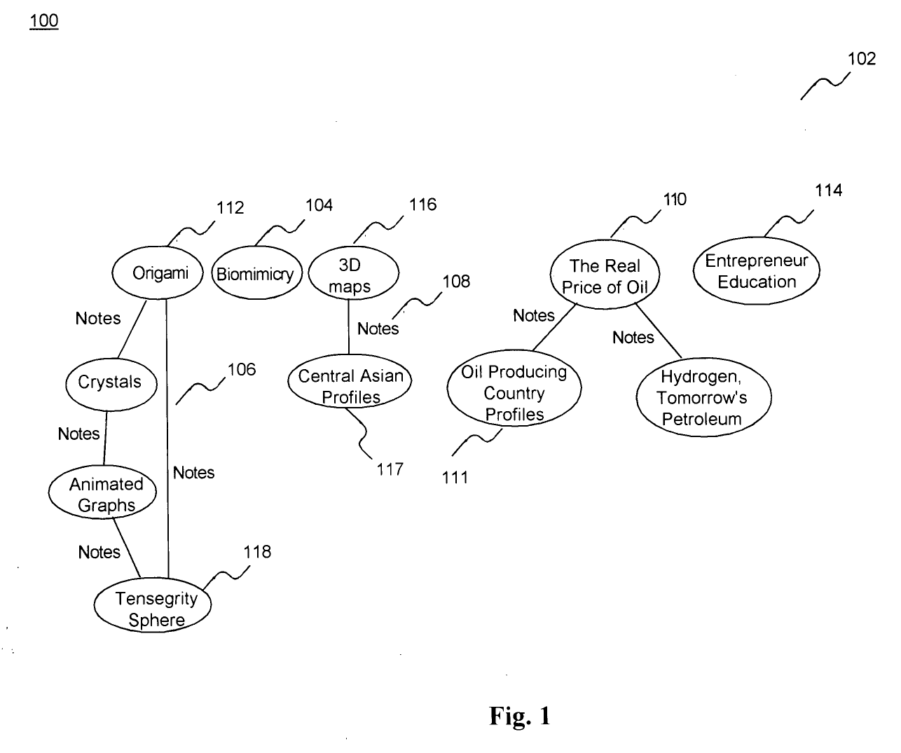

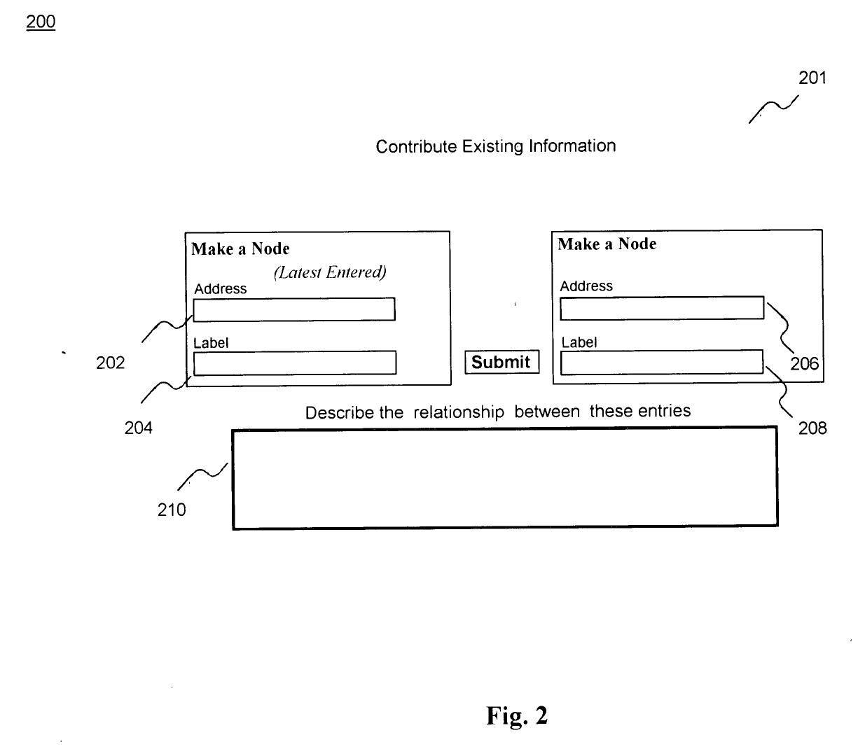

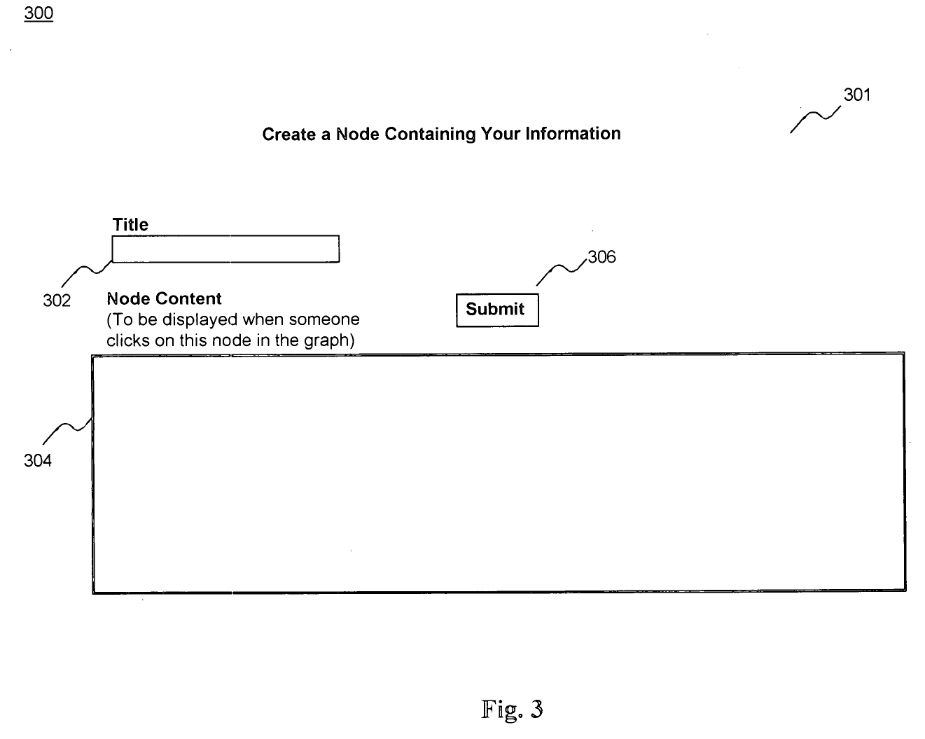

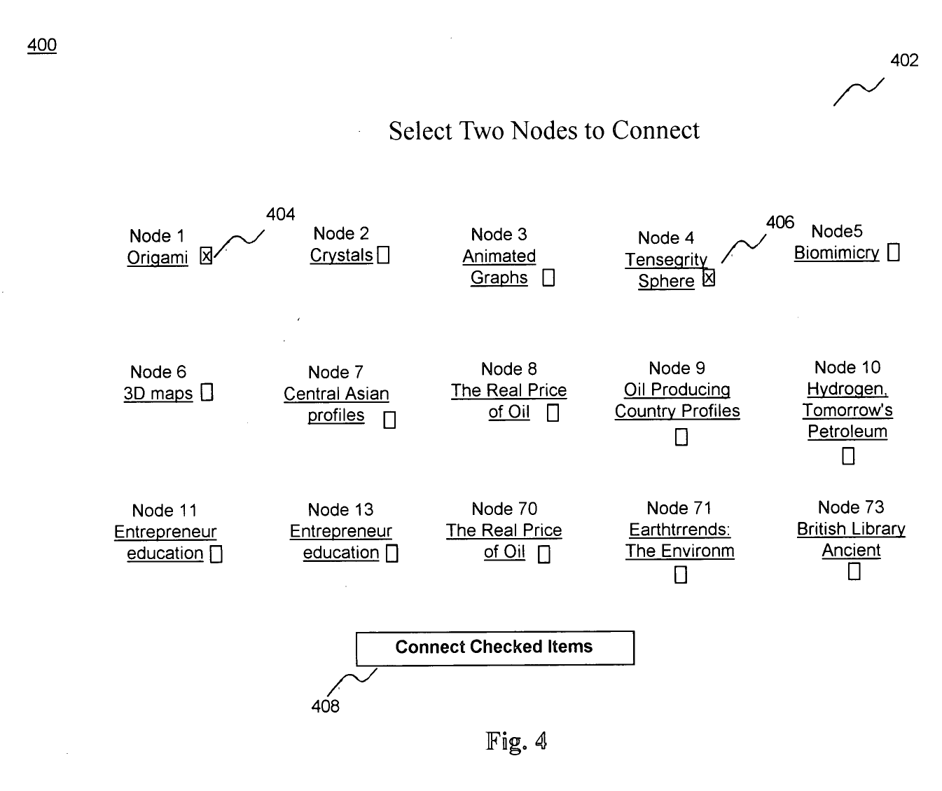

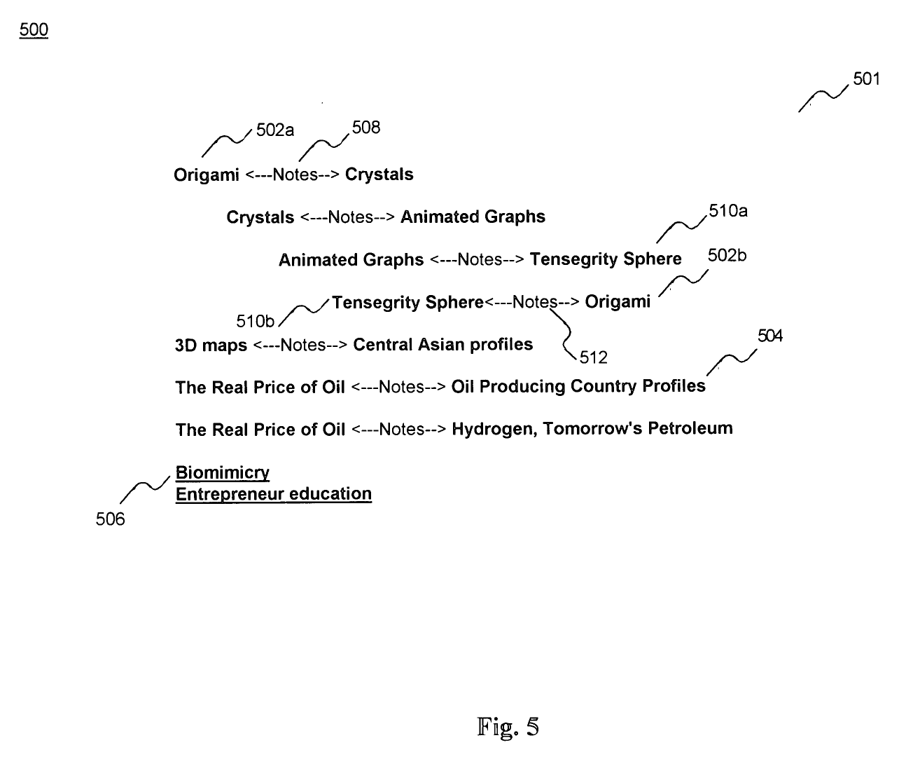

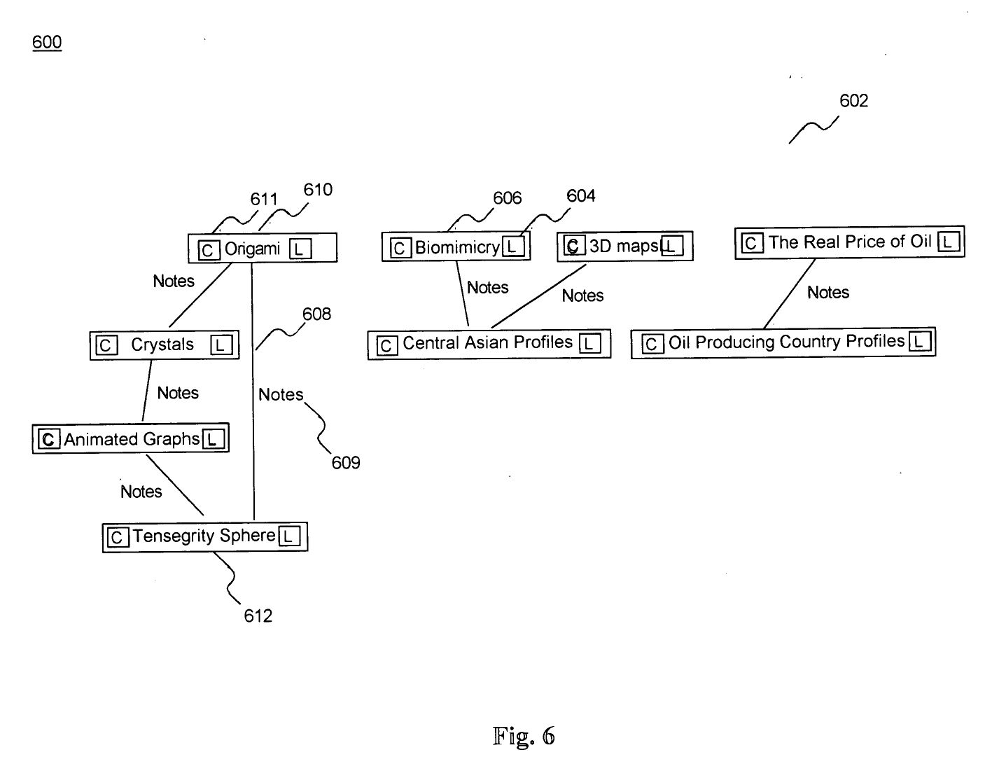

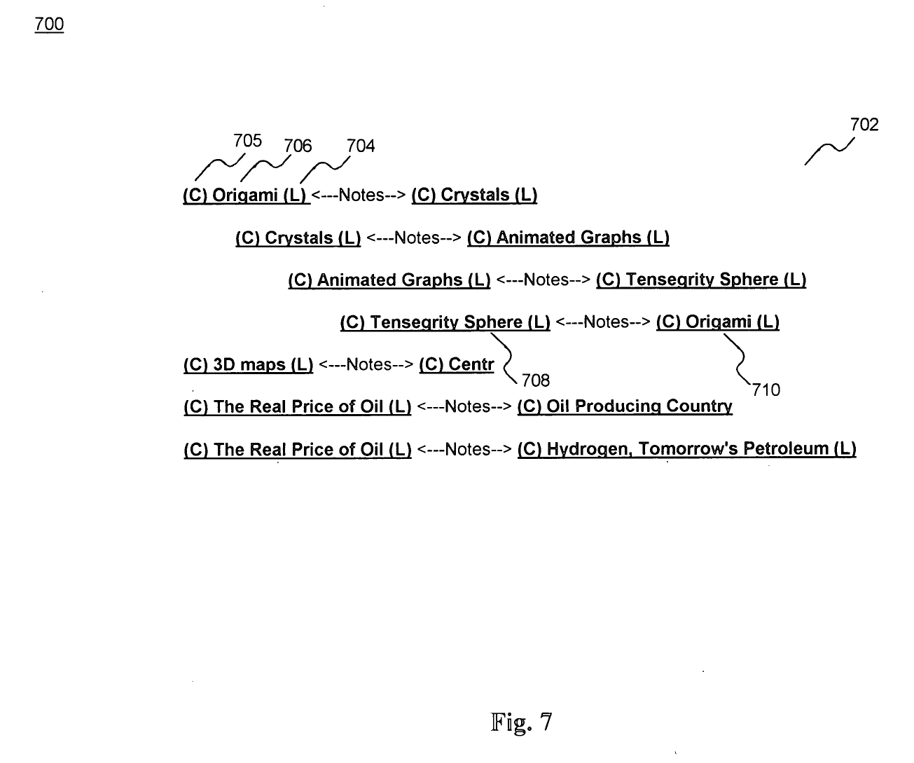

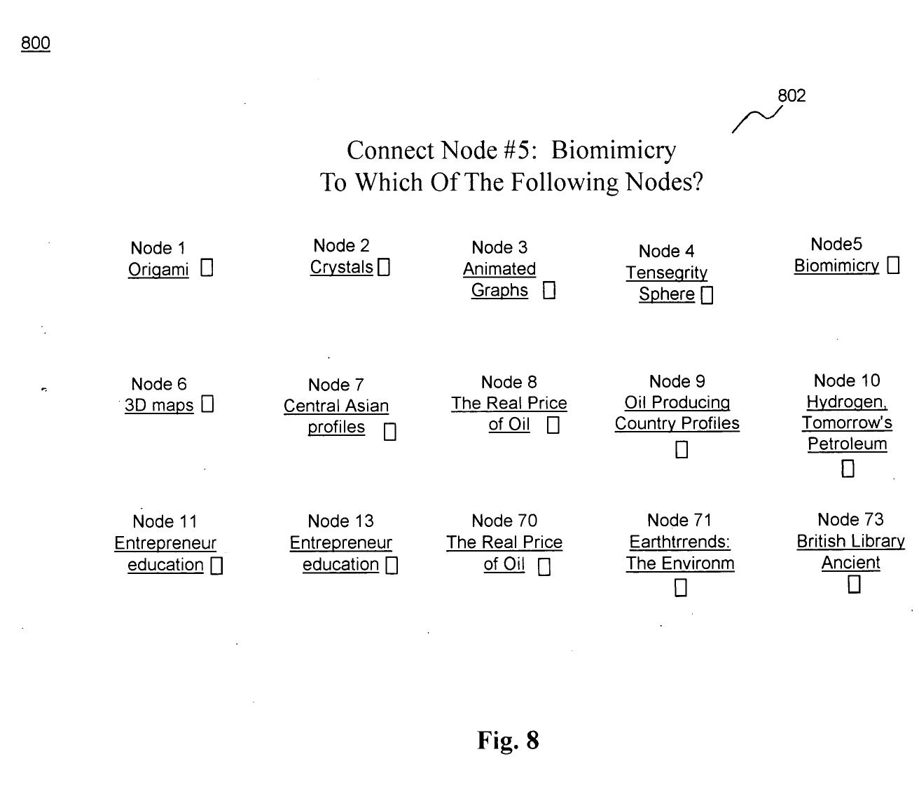

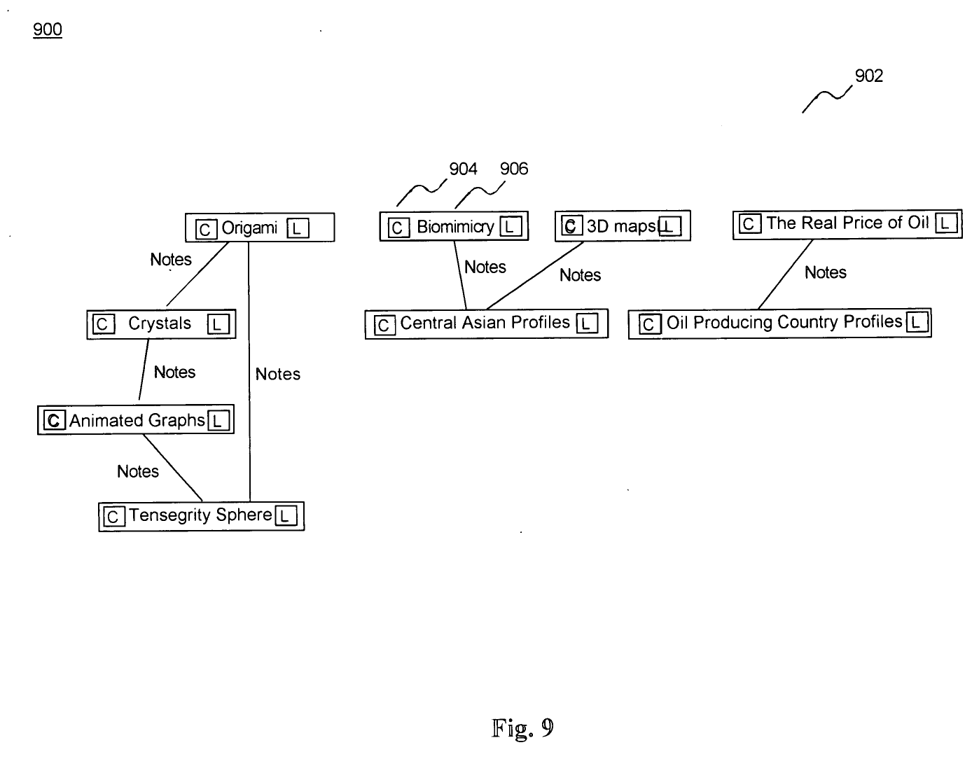

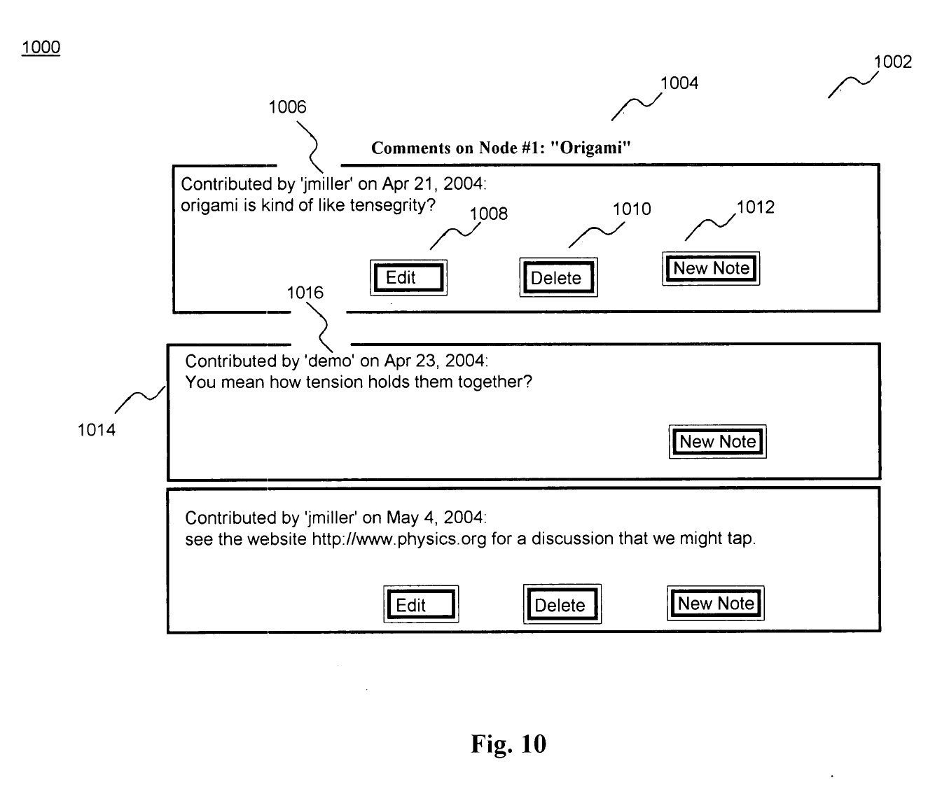

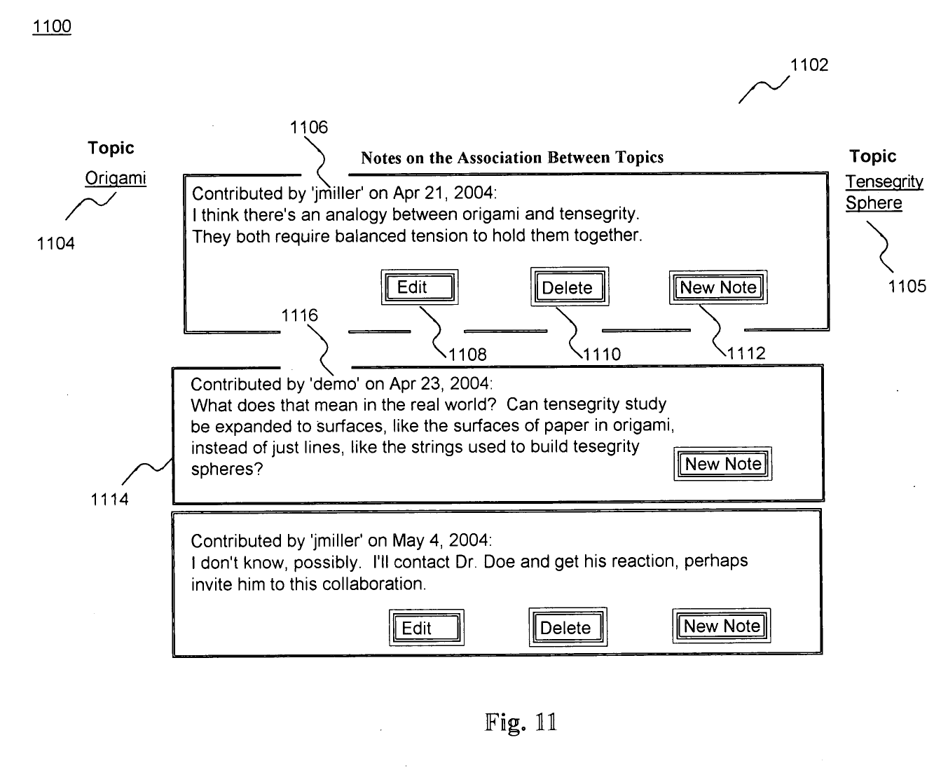

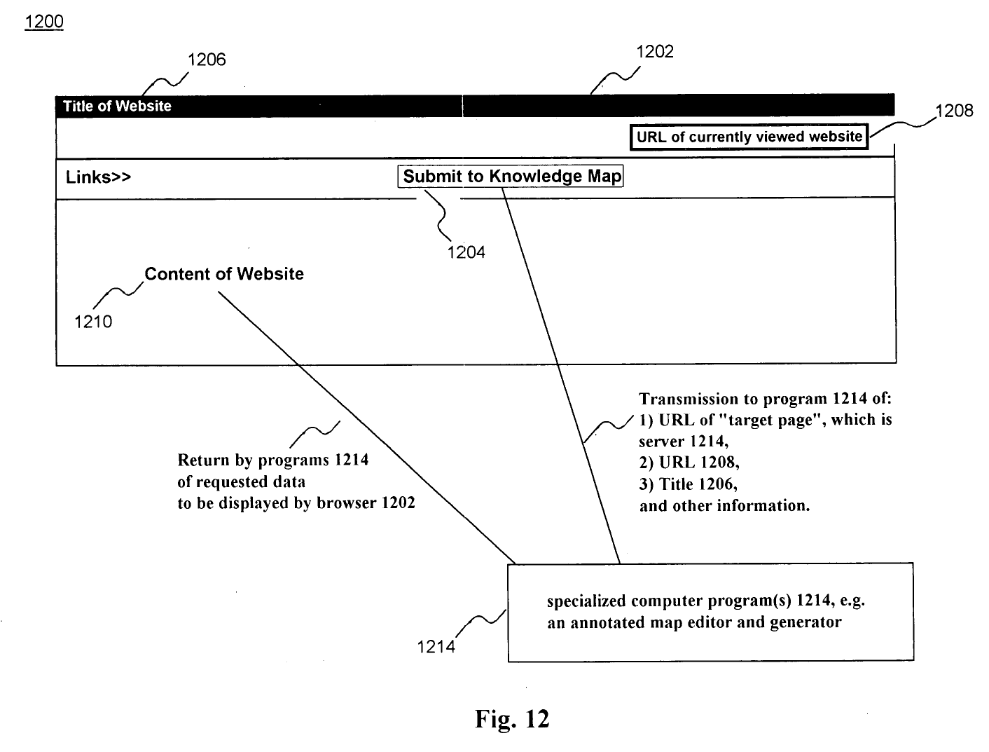

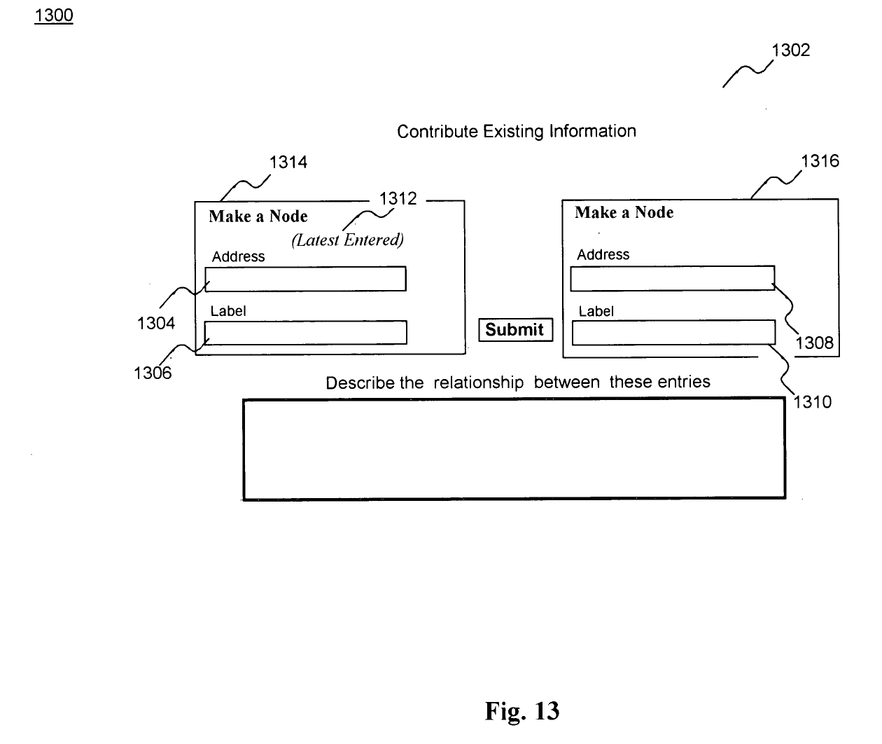

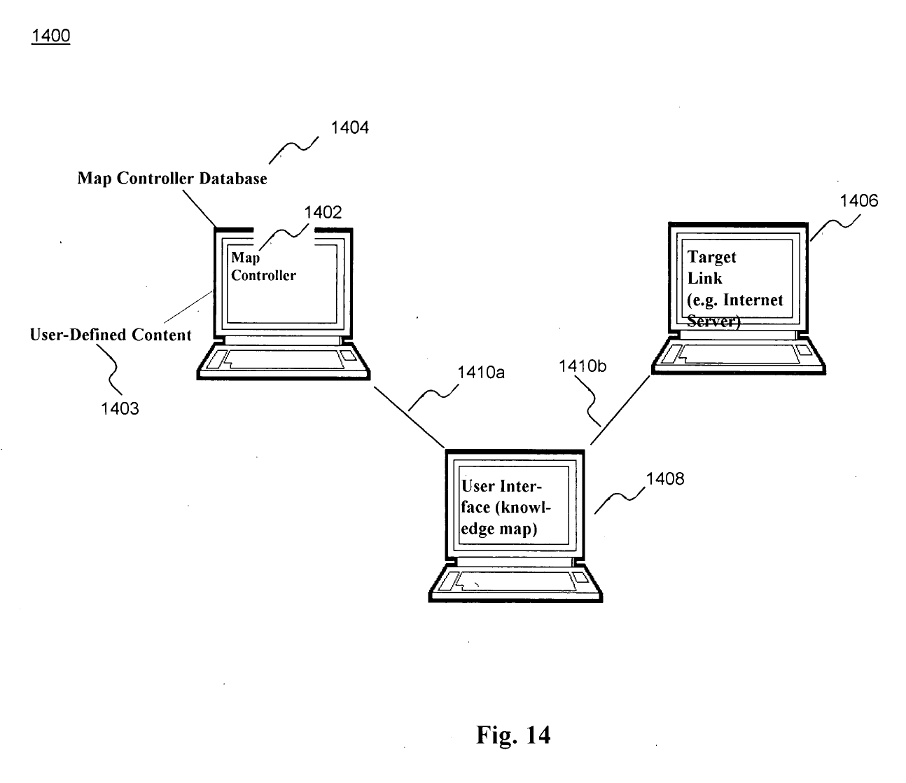

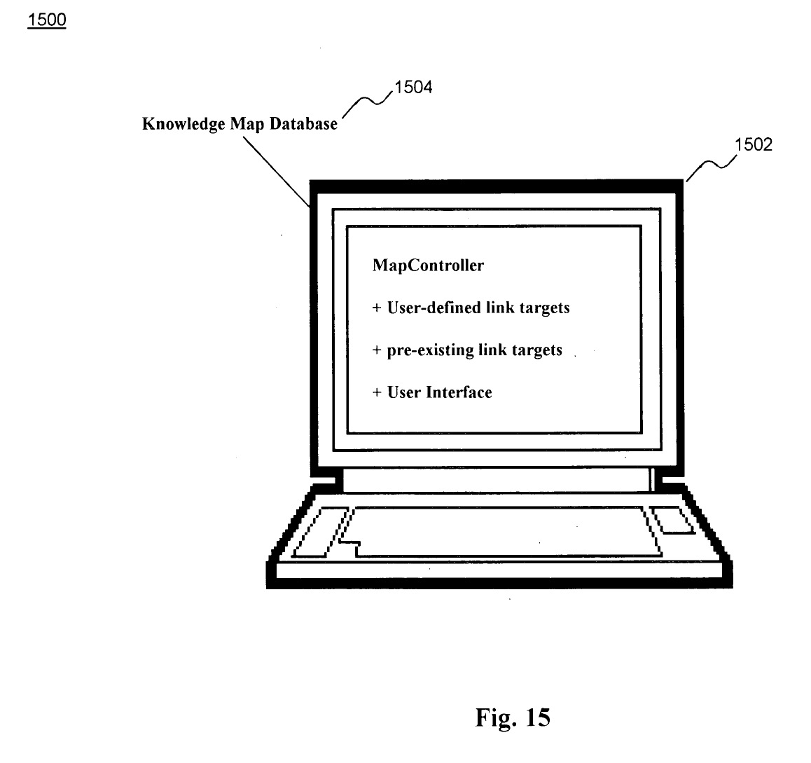

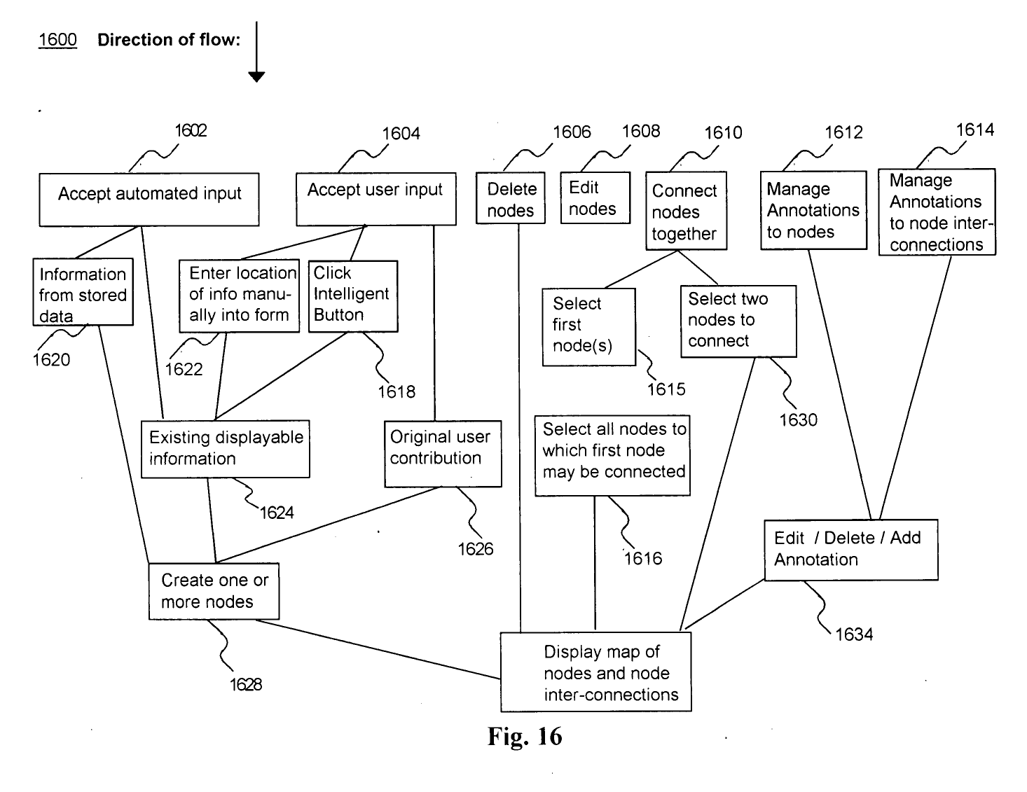

### BACKGROUND OF THE INVENTION

1. Field of the Invention

The present invention is related generally to the field of computers, computer networks and apparatus for use in displaying information. More particularly, the invention comprises equipment and methods for constructing and displaying, in simple-to-use form, an arrangement of nodes which contain hypertext or non-hypertext links, the nodes being in hierarchical or non-hierarchical relationships, including annotation of the relationships between the nodes for further describing the nature of the relationship between connected nodes.

2. Background and Related Art

The collection of information into easily readable and accessible form has been the subject of much research. The effect of computers and the Internet on the amount of information available to the individual user, and the subsequent difficulty of managing that information in a usable way, has been widely noted.

A technical problem exists at present in providing a system which combines easy-to-use and easy-to-update data displays which depict selected information, group or user comments and annotations on such information, collaborative arrangement of information in ways that indicate relationships between the information, group or user comments and annotations on such relationships, easy contribution of existing and of novel information, and collaboration over distance addressed in one method or system.

The problem of organizing the contributions of a group of people has been addressed extensively since the inception of the Internet, notably by the popular adoption of “weblogs”, the serial posting of comments on a particular topic by a group of users. This solution, however, still suffers from difficulty in a) organizing all comments for easy readability in one place, and b) enabling easy access to referenced materials, such as other weblogs and resources. While democratic discourse is enabled, information still tends very quickly to become scattered.

“Mind Mapping” is another organizational technology which provides a graphic interface for building hierarchically arranged labels representing mental concepts. It is used to give logical order to what is known by a user or users and represent it visually. However, they could benefit from rich content, that is, labels that represent greater amounts of information than is visible in the label itself, via hypertext or other means. More importantly, the development of a cognitive map by a group may follow unstructured paths, and limiting the placement of knowledge within a map to specific categories or hierarchies is limiting. While such limitation may have its place in organizing of knowledge, creative thought and the generation of new associative knowledge need more flexible means.

However, the availability of a broad view, a cognitive map, is important in developing a group's ability to locate resources and expertise of various kinds. To this end, many research efforts have been made in the realms of visualization of data and of cognitive mapping. The preponderance of these efforts focus on solutions involving automated extraction of meaning and categorization of knowledge. Unfortunately, automated methods are not inherently creative, miss the large preponderance of information that is contained in human knowledge and not stored in any computer database, and cannot find relationships between seemingly disparate elements, such as a journal article, a personal conversation, and a video clip.

The above principles of effective group operation also apply to an individual who is working alone to organize a body of knowledge or generate novel solutions.

Attempts to solve the current technical problem have included methods of graphical representation of data representing information sources. Such graphical representation is commonly used to illustrate collected knowledge and resources and will be illustrative of the prior art. For this purpose we describe a system in which each entity of knowledge or data available is represented by a graphic object or non-graphic text object called a “node”, which represents information, knowledge or data. Additionally, such nodes may be connected in a relationship, commonly indicated visually by a connecting line between nodes. Such lines indicating relationship between nodes will be known to one skilled in the art as “edges”, or “vectors”.

Directed and non-directed graphs have wide use in science and technology, including but not limited to: mapping link relationships between web sites, visualizing data, visualizing computer file system structures, mapping execution flows through computer source code, mapping network topographies, literature maps, categorization of knowledge and execution rules in expert systems and artificial intelligence programs, and the construction of automated decision support systems.

One or more of the following restrictions characterizes current attempts to solve the described technical problem by known applications of collaborative systems, knowledge aggregators and system mapping programs:
1) are hierarchical, requiring that data be related in strict parent-child fashion
2) are designed to represent the results of automated searches or have limited or non-existent facilities for human user input to capture data or relationships between data not accessible to data processing systems, such as purely human knowledge not contained in any database, or data or relationships between data from disparate knowledge domains, e.g. a knowledge relationship between an unrecorded personal conversation, a journal article, and a video clip.
3) fail to allow human intervention to bypass automated tools that perform tasks such as extraction of relationships, clustering and classification of data, determination of causal hierarchy, or determination of the weighting of relationships
4) require that connections between nodes be constrained to a type, for example node A “is-a”, or “is-contained in” node B.
5) do not allow cyclic relationships
6) are constrained into a directed graph structure, in which relationship order is in one direction only, i.e. parent to child
7) require that data be categorized according to knowledge or subject domain and placed in the graph according to category, rather than accepting free-form input to be placed in context however the user desires
8) lack graphic facilities for displaying specific relationships between graph nodes, for example connecting lines between nodes or node placement relative to other nodes
9) lack facilities for easily and quickly constructing relationships between nodes as desired by the user so that their visual arrangement reflects these relationships, i.e. “connecting” nodes, especially by selecting from a given node all the nodes to which it should be connected.
10) lack facilities for attaching annotations to nodes. Such annotations might be the opinions and reflections of users on the content of the node, or machine-generated summaries of node content made easily visible to users for further comment and expansion.
11) do not allow annotations to nodes to be displayed in one place while simultaneously displaying the nodes to which said comments and annotations refer
12) do not allow annotations to nodes to be displayed while simultaneously displaying access to editing facilities for said annotations, with access permissions determined by the identity of the user viewing said annotations
13) lack facilities for annotating with reasons and opinions the relationships between nodes, not just the nodes themselves. In graph terms, this would be denoted by information associated with the “edges” or “vectors” between nodes, not just the nodes themselves
14) do not allow comments and annotations to “vectors” or “edges” between nodes to be displayed in one convenient place while simultaneously displaying the nodes to which said comments and annotations refer
15) do not allow comments and annotations to “vectors” or “edges” between nodes to be displayed while simultaneously displaying access to editing facilities for said comments and annotations, with access permissions determined by the identity of the user viewing said comments and annotations
16) lack facilities for automatic creation of nodes by extracting information from existing Internet or Intranet web sites, and allowing user control such that any web site may be selected to be represented as a node, an example of such selection being clicking a button provided on the user's Internet browser program which extracts the relevant information about that web site needed to construct a node and transmits such information to the graph generation program.
17) lack facilities for user creation of nodes containing original material supplied by the user
18) lack facilities for intelligent form management so that in the course of entering information for creation of a node or nodes, the entry fields are automatically selected so that empty fields are selected, or in the case where no empty fields are available, the oldest data is overwritten and the latest entered is preserved, freeing the user from tracking the order in which information is entered
19) require peer-to-peer computer data sharing
20) are characterized by specificity of design, i.e. they are typically designed for business, scientific, sociology or computer professionals for a specific use, and require a certain level of domain-specific knowledge in order to participate effectively
21) impose restrictions upon the content represented by nodes, failing to allow nodes to represent identification, description, and recall of multimedia, collaborative, intellectual, conceptual, factual, or functional information of arbitrary type and format
22) do not make use of remote access via telecommunications links
23) are not automated using computers, networks, peer-to-peer systems, client-server systems, or other mechanical or electrical means.

Specific attempts to solve this problem, each of which contains one or more of the restrictions described above, are described in the following patents. Most of the referenced patents following contain several of the above listed restrictions, the most general of which will be specified. Parts or all of limitations 9, 16, and 18 above are characteristic of all of the following patents.

A process for generation of hierarchical taxonomy of documents was disclosed by Doerre, et al. in “Taxonomy generation for document collections”, U.S. Pat. No. 6,446,061, the contents of which is incorporated herein by reference in its entirety and included in illustration of limitation #1 given above, the restriction to hierarchical relationships.

An interactive rule based system enabling problem solutions to be generated in schematic diagram form was disclosed by Dunn in “Schematic diagram generating system using library of general purpose interactively selectable graphic primitives to create special applications icons”, U.S. Pat. No. 4,656,603, the contents of which is incorporated herein by reference in its entirety. Said patent is included in illustration of restriction #2 given above, the lack of complete knowledge domain independence, since “the system of the present invention builds rules on the basis of procedure within a field of intent” and “the system thereby precludes interference between intents”, and of restriction #20 given above, being characterized by specificity of design by business, scientific, sociology or computer professionals for a specific use.

A knowledge system incorporating a graphic display which allows the user to select displayed “chunks” of knowledge and to perform a command to display the links to other chunks of knowledge was disclosed by Rappaport, et al. in “Dynamic, interactive display system for a knowledge base”, U.S. Pat. No. 4,752,889, the contents of which is incorporated herein by reference in its entirety. Said patent “replaces by an automatic process the handwork of linking chunks together”, and is referenced here in illustration of restrictions #3 and #7 given above, lacking facilities to allow human intervention to bypass automated tools and create relationships of a completely free-form nature.

A data processing system for storing data such as chemical structures, geographic locations, taxonomy, genus synonyms, and textual descriptions and related natural products images such as images of the organisms, correlated with the natural products data to allow display of the images with the related data was disclosed by Dietzman in “Natural products information system”, U.S. Pat. No. 5,978,804, the contents of which is incorporated herein by reference in its entirety and included in illustration of limitation #1 given above, the restriction to hierarchical relationships or taxonomies and of limitation #20 given above, being characterized by specificity of design by business, scientific, sociology or computer professionals for a specific use.

An invention providing a logical tree which graphically illustrated the logical interconnection between nodes of information previously input by a contextual editor for an expert system was disclosed by Derr, et al. in “Editor for expert system”, U.S. Pat. No. 4,891,766, the contents of which is incorporated herein by reference in its entirety and and is referenced here in illustration of restrictions #3 given above, lacking facilities to allow human intervention to bypass automated tools and of restriction #7 given above, lacking facilities for the user to create relationships of a completely free-form nature.

A user-controlled interactive computer display system for manipulating a hierarchy of information from a single, topmost node was disclosed by Hess in “Display system and method for constructing and editing a hierarchical arrangement of information”, U.S. Pat. No. 4,764,867, the contents of which is incorporated herein by reference in its entirety and included in illustration of limitation #1 given above, the restriction to hierarchical relationships.

The application of a graph in the form of nodes which represent concepts in the domain of knowledge, called a “concept-graph”, with links between the concept nodes, and icons, was disclosed by Ford, et al. in “Concept map-based multimedia computer system for facilitating user understanding of a domain of knowledge”, U.S. Pat. No. 5,506,937, the contents of which is incorporated herein by reference in its entirety and included in illustration of limitation #1 given above, the restriction to hierarchical relationships and of limitation #10 given above, the lack of facilities for attaching annotations to nodes.

An invention for representing the results of a search of a database via a hierarchical tree structure in which detail is selected and context preserved was disclosed by Bowers, et al. in “Method and apparatus for visualization of database search results”, U.S. Pat. No. 5,546,529, the contents of which is incorporated herein by reference in its entirety and included in illustration of limitation #1 given above, the restriction to hierarchical relationships, of limitation #10, the lack of facilities for attaching annotations to nodes, of limitation # 13, the lack of facilities for annotating with reasons and opinions the relationships between nodes, not just the nodes themselves, and of limitation #5, not allowing cyclical relationships between nodes.

An authoring system for constructing a directed graph depicting questions and their answers, in which the question nodes and the answer nodes are connected to one another by uni-directional links was disclosed by Kim in “Authoring knowledge-based systems using interactive directed graphs”, U.S. Pat. No. 5,673,369, the contents of which is incorporated herein by reference in its entirety and included in illustration of limitation #1 given above, the restriction to hierarchical relationships, of limitation #6, restricting graph structures to directed graphs, and of limitation #5, not allowing cyclical relationships between nodes.

An automated program for analyzing the internal linking relationships between web sites and building a hierarchical, parent-child site map which graphically depicts the URLs and links of the site was disclosed by Weinberg, et al. in “Visualization of web sites and hierarchical data structures”, U.S. Pat. No. 6,144,962, the contents of which is incorporated herein by reference in its entirety and included in illustration of limitation #2 given above, the restriction of representing the results of automated searches with limited facilities for human user input.

It should also be noted that the analysis disclosed in U.S. Pat. No. 6,144,962 is of the links made between web sites by references in their internal computer code, as opposed to higher level conceptual links between web sites by semantic meaning determined by human users or other means.

A method for creating and displaying a categorized knowledge map wherein the space of the map is preferably divided into different sections representing a particular category of knowledge was disclosed by Sivan in “Method for creating a knowledge map”, U.S. Pat. No. 6,421,066, the contents of which is incorporated herein by reference in its entirety and included in illustration of limitation #7 given above, the requirement that data be categorized according to knowledge or subject domain and placed in the graph according to category.

A mapping between physical objects placed on a board which represent concepts and processes with associated data processing functions was disclosed by Moran, et al. in “Surface mounted information collage”, U.S. Pat. No. 6,005,482, the contents of which is incorporated herein by reference in its entirety and included in illustration of limitation #13 given above, lacking facilities for annotating with reasons and opinions the relationships between nodes (nodes being termed “components” in said patent), and of limitation #22, not making use of remote access via telecommunications links

The aforementioned disclosures can be characterized as systems designed to perform functions relating to the capture of knowledge data, the display of knowledge or data in manageable cells, and/or the pairing of such cells with other relevant cells.

However, none of these systems:
a) include facilities for definition of arbitrary relationships between data by a single user or a collaborative group of users, while allowing hierarchical or non-hierarchical, cyclical or non-cyclical, directed or non-directed relationships between nodes, or allowing no relationship or connection between nodes at all;
b) include facilities for constructing relationships between nodes by selecting from a given node all the nodes to which it is desired that it be connected; and
c) include facilities for attaching, editing, and deleting annotations to the relationship between nodes;
The present invention provides a technical solution to this problem by providing a system which overcomes these limitations, making collaboration among disparate, geographically dispersed users more efficient by enabling them to jointly define relationships between information that formerly were not readily apparent, to annotate those relationships and that information, while providing easy access to said information and contribution of new information in a way which does not constrain the relationship or information pointers to a fixed format such as a hypertext link.

### SUMMARY OF THE INVENTION

The present invention sets forth a method of capturing and organizing in a structured or non-structured way the relationships and associations between information or functions in a visual map, with said information or functions being represented by text or graphic labels, commonly called nodes by those skilled in the art, for example text or graphic icons linked to Internet locations.

The system of the present invention is generally comprised of a computer having a display for displaying said nodes “nodes” and an editing application for
a) adding or modifying said nodes,
b) defining connections between nodes,
c) adding or modifying comments or further information to be associated with the connections between nodes, such annotation represented in one embodiment by a hypertext or non-hypertext label located adjacent to a graphic line connecting two graphic node icons,
d) adding or modifying comments or further information to be associated with the nodes themselves, such annotation represented in one embodiment by a hypertext or non-hypertext link within or adjacent to the node,
e) specifying the interconnections desired between nodes. In one exemplary embodiment such connections are specified by selection of a hypertext or non-hypertext link associated with a particular node, which opens a user interface listing all other nodes available for connection to said node. In another a user interface unassociated with a particular node is displayed from which the user may select nodes for interconnection.
f) Managing form entry in an automated manner such that the user does not have to specify which entry fields are available or appropriate for data entry, and
g) providing an “intelligent” one-button entry function which extracts information for node construction and automatically sends the information to the node construction system,
plus a database system for storing data required for construction of the above-mentioned map and for management of the editing application. Such data may include but is not limited to information related to node content, to node inter-connections, annotations to nodes, annotations to node inter-connections, and relevant user information.

The system of the present invention may further employ networking communications to enable joint collaboration on a map or maps by a plurality of users.

While the present disclosure highlights human collaboration as an exemplary example of use of the present invention, the characteristics of the present invention, including its adaptability to any topography of nodes, ease of modification to maps, and particularly the facilities for annotation of connections and of nodes lends itself to other applications. As one example, the present invention could be used without modification to map the network topology of distributed environmental sensors which broadcast their current operating state, viewable at a given computer-addressable location, which is a common capability of such sensors. The facility provided in the present invention for annotation of connections could be used by human operators to comment on measurement trends observed, maintenance needs, etc.

The method herein disclosed and the map thus organized can be visually displayed using a variety of available map visualization systems, for example computer products designed to graphically render knowledge maps, cognitive maps, or data visualization. The method herein disclosed enables the capturing, editing, and organization of information and annotations, and visual display may be accomplished by a variety of means, the present invention supplying the data and relationship information to the chosen program or system for display.

The method herein disclosed can be implemented on a computer system that can include one or more computers, one or more databases, and optionally, a network connecting the computers. The computer system in one exemplary embodiment can be implemented using a peer-to-peer computer system; and in another can be implemented using a client-server system; and in a third can be implemented on a single computer unconnected to other computers.

In an exemplary embodiment, the entity identifiers can have arbitrary data types and formats.

In an exemplary embodiment, the entities can have arbitrary data types and formats.

In an exemplary embodiment, the system can further include a database coupled to a map controller.

In an exemplary embodiment, the map controller, the link target or targets, user-defined content, and the user interface can be coupled together by a network.

In an exemplary embodiment, the map controller, the link targets, user-defined content, and the user interface can be embodied on a single computer system or any combination of networked and standalone computers.

In an exemplary embodiment, a computer program product embodied on a computer readable medium is disclosed, the computer program product can include computer program logic for capturing and visualizing relationships and associations between information with said information being represented by entity identifiers denoting underlying data, and further of entering and retrieving annotations to the connections between entity identifiers.

Further features and advantages of the invention, as well as the structure and operation of various exemplary embodiments of the invention, are described in detail below with reference to the accompanying drawings. In the drawings, like reference numbers generally indicate identical, functionally similar, and/or structurally similar elements. The leftmost digits in the element's reference number indicate the drawing in which an element first appears.

### BRIEF DESCRIPTION OF THE DRAWINGS

The foregoing and other features and advantages of the invention will be apparent from the following, more particular description of an exemplary embodiment of the invention, as illustrated in the accompanying drawings.

Drawing 1 depicts an exemplary embodiment of an annotated map.

Drawing 2 depicts an exemplary embodiment of an interface for entry of new entity identifier(s) referring to pre-existing content, referred to herein as link target(s), and optionally, an annotation on the relationship between two entity identifiers.

Drawing 3 depicts an exemplary embodiment of an interface for entry of a new entity identifier linked to original information supplied by the user.

Drawing 4 depicts an exemplary embodiment of an interface for connecting entity identifiers.

Drawing 5 depicts an exemplary embodiment of a map in textural, rather than graphic form.

Drawing 6 depicts another exemplary embodiment of an annotated resource map with the addition of hypertext or non-hypertext links to each node to enable connecting said node to an arbitrary collection of nodes.

Drawing 7 depicts an exemplary embodiment of the system illustrated in Drawing 6 as applied to a textural representation of the graph.

Drawing 8 depicts an exemplary embodiment of a dialog to allow selection of nodes to be connected to a given node.

Drawing 9 depicts another exemplary embodiment of an annotated resource map with the addition of hypertext or non-hypertext links to each node to enable editing or viewing annotations to the node itself.

Drawing 10 depicts an exemplary embodiment of a display for viewing, editing, or adding new annotations to a given node.

Drawing 11 depicts an exemplary embodiment of a display for viewing, editing, or adding new annotations to the connection beween nodes.

Drawing 12 depicts an exemplary embodiment of an intelligent Link button for the purpose of extracting relevant information concerning displayed data and transmitting said information to the target application, in the present example a map capturing and organizing application.

Drawing 13 depicts an exemplary embodiment of the mechanism for smart entry form management, which automatically detects the best available entry form fields for use.

Drawing 14 depicts an exemplary embodiment of a topology for connecting the computer platforms used to implement the present invention.

Drawing 15 depicts an alternate embodiment of the present invention implemented on a single computer platform.

Drawing 16 depicts a flowchart summary of operation of the present invention.

### DETAILED DESCRIPTION OF THE INVENTION

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

The invention also relates to apparatus for performing the operations herein. These apparatus may be specially constructed for the required purposes, or may comprise a general-purpose computing or electronic device selectively activated or reconfigured by a program stored in the device. Such a program may be stored in a machine-readable storage medium, such as, but not limited to, any type of magnetic or other disk storage media including floppy disks, optical storage media, CD-ROMs, and magnetic-optical disks, read-only memories (ROMs), random access memories (RAMs), EPROMs, EEPROMs, magnetic or optical cards, flash memory devices; electrical, optical, acoustical or other form of propagated signals (e.g., carrier waves, infrared signals, digital signals, etc.); etc. or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A user interface in accordance with the present invention can be used to explore any kind of hierarchy of information, for example, directories, query result sets (from databases engines, search engines, etc.), file stores, etc. Furthermore, the user interface contemplated by the present invention can be used on or in conjunction with any platform that has a pointing device (e.g., mouse, trackball, stylus, directional pad, remote control, etc.), including personal computers, Internet appliances, personal digital assistants, telephones, mobile or cellular telephones, television sets, etc. It is also contemplated that the user interface can be controlled through speech, eye movement, and other modalities.

Hereinafter, the term “computing platform” refers to a particular computer hardware system or to a particular software operating system. Examples of such hardware systems include, but are not limited to, personal computers (PC), Macintosh.™. computers, mainframes, minicomputers and workstations. Examples of such software operating systems include, but are not limited to, UNIX, VMS, Linux, MacOS.™., Palm OS, DOS, one of the Windows.™. operating systems by Microsoft Inc. (Seattle, Wash., USA), including Windows NT.™., Windows 3.x.™. (in which “x” is a version number, such as “Windows 3.1.™.”), Windows95.™., Windows98.™. and Windows CE.™.

The present invention could be described as a series of steps implemented by a data processor, such that the present invention could be implemented as hardware, software or firmware, or a combination thereof. For the present invention, a software application could be written in substantially suitable programming language, which could easily be selected by one of ordinary skill in the art. The programming language chosen should be compatible with the computing platform according to which the software application is executed. Examples of suitable programming languages include, but are not limited to, C, C++ and Java.

A preferred embodiment of the invention is discussed in detail below. While specific implementations are discussed, it should be understood that this is done for illustration purposes only. A person skilled in the relevant art will recognize that other components and configurations may be used without parting from the spirit and scope of the invention.

The present invention sets forth a method of capturing and visualizing relationships and associations between information in a visual representation, with said information being represented by entity identifiers of arbitrary format and type, for example by text labels or graphic icons denoting underlying data or function. Underlying data in one exemplary embodiment consists of addresses corresponding to Internet locations.

Said entity identifiers linked to associated data is herein termed a “node”. A collection of said nodes is herein termed a “map”.

The present invention further sets forth a method of entering and retrieving annotation on the relationship between knowledge nodes with the connections between nodes, such annotation represented in one embodiment by a hypertext or non-hypertext label located adjacent to a graphic line connecting two graphic node icons.

Drawing 1 depicts diagram 100 of an exemplary embodiment of the present invention, including: a graphic map 102 of nodes 104 and similar, and optional connections 106 and similar between nodes in the map, denoted by drawn lines. The nature of the connection between any two nodes may be either directed (unidirectional), typically indicated by an arrow connecting nodes, or non-directed (bi-directional), typically indicated by a simple line between nodes, as shown in Drawing 1. The arrangement of nodes thus constructed may be hierarchical (110 and its connected nodes) or non-hierarchical (112 and its connected nodes), including circular relationships. Nodes may also remain unconnected, 114 and similar. In the preferred embodiment said connections are not typed, for example being restricted to denoting “is-a” or “is-a-member-of” relationships. This lack of typing yields a preferred freedom from constraints for categorizing information within hierarchical relationships. However, the present invention may be implemented in such a way that connections are in fact typed without stepping outside the bounds of the present invention in any way.

Annotations 108 on the connecting inter-node relationships are denoted by links from the word “Notes” in the present example of an exemplary embodiment. It will be recognized by one skilled in the art that the annotation may be indicated in any way desired, for example by arbitrary text or graphic icon, without altering the present disclosed invention of associating a hypertext or non-hypertext annotation with a node interconnection. The present invention provides facilities for adding new annotations, editing such annotations, and deleting annotations. The use of links to annotations provides the benefit of accessibility to many annotations on a given topic by opening a separate window for viewing while maintaining a neat appearance and immediately recognizable context to the topic of the annotations in the map.

Drawing 2 depicts diagram 200 of an exemplary embodiment of the present invention, displaying a preferred, but optional, user interface for generation of a new node or nodes for a map. It includes of user entry areas for the Universal Resource Locator (URL hereafter) address 202 to be associated with a new node (for example, 104 in Drawing 1), and a human-readable label 204 by which the new node will be visibly named. According to the present invention the necessary input data may be entered into areas 202 and 204 by any means, whether by typing, cut-and-paste, automated process, or other means, and stored in database 1404 depicted in Drawing 14. The representation of Internet page addresses or locations in the user interface 200 and stored in database 1404 associated with the Map Controller 1402 may be chosen as desired, whether, e.g., Universal Resource Locator addresses, abstract references of an invented data type, or some other data type. Alternative methods of addressing data may be substituted throughout the present invention and terms denoting them may replace the term “URL” throughout the present invention without leaving the scope of the present invention. The term ‘database’ as used herein means a collection of independent works, data or other materials which are arranged in a systematic or methodical way, and are individually accessible by electronic or other means, and which may include data stored in memory or in a flat file. The inputs to the system of the invention may be by a special automated process, where the special automated process may be document scanning computer programs or content provider systems or programs one example being the RSS (Resource description framework Site Summary or Rich Site Summary) content provider system.

Drawing 2 also depicts secondary user input areas 206 and 208, for input of an optional second URL and label. In the present preferred embodiment this provides the capability of generating two nodes simultaneously, with an annotation concerning the relationship between the nodes to be given by the user in input area 210. In this way the user may input two nodes, for example 1116, 117, and a comment link 108 on the connecting relationship at the same time.

Drawing 3 depicts diagram 300 of an exemplary embodiment of the present invention, displaying a preferred user interface 301 for input of data for the generation of a new node containing user-defined information. Drawing 3 includes user input area 302 for entry of a human-readable label by which the new node will be visibly named, fulfilling the same function as input area 204 or 208.

Drawing 3 also depicts user-input area 304 for entry of user information, the information to which the generated node will be linked via hypertext or non-hypertext link. According to the present invention the necessary input data may be entered into area 304 by any means, whether by typing, cut-and-paste, automated process, or other means. After entry of user data, the clicking of button 306 causes the generation of a single node similar to 114 in map 102.

Drawing 4 depicts diagram 400 of an exemplary embodiment of the present invention, displaying a preferred user interface for input of data for the connection of nodes in relationship. Drawing 4 includes data cells 404, 406 and similar, displaying information corresponding to each node available for inter-connection. In the present embodiment the user selects two cells using the provided check boxes and clicks the submit button 408 whereupon the two corresponding nodes in the map 102 are redrawn with a line connecting, indicating a relationship between the knowledge or information represented by the node. For example, clicking box 404 and box 406, followed by clicking button 408, would result in the map being subsequently drawn with a line 106 between nodes 112 and 118, as shown. The same relationship is illustrated by line 608 connecting nodes 610 and 612, or 512 connecting nodes 502b and 510b.

An alternate method for selecting more than two cells at once is presented in Drawing 8 and its accompanying description.

Drawing 5 depicts diagram 500 of an exemplary embodiment of the present invention, displaying a preferred user interface 501 for display of the map in purely textural form with nodes represented by non-graphic hypertext or non-hypertext links. A purely textural form enables full functioning of the present invention in environments where graphical displays are not available (e.g. text-only systems), where structured text form is preferred for displaying graphs containing large numbers of nodes, or where the use of text searching tools is desired.

Link 502a corresponds to graphical node 112, and links 504, 506 and similar correspond to their similarly named nodes (respectively “Oil Producing Country Profiles” 111, and the unconnected node “Biomimicry” 104) in drawing 102.

What is claimed as unique in Drawing 5 is the annotations denoted by the links marked “Notes”, 508 and similar, with function identical to those previously discussed in this disclosure in the description of Drawing 1, item 108 and similar.

Circular relationships are denoted with text, without need for graphical display capabilities, by successive indentations leading to a repeat of the leftmost node, for example 502a and 502b. It will be seen upon examination that all the nodes which make up a cycle may be detected as being part of a circular relationship in the same way, for example 510a, appearing rightmost in its line, also appears as 510b, leftmost in a different line, but indented.

Drawing 6 depicts diagram 600 of an exemplary embodiment of the present invention, displaying map 602, an alternate map view with the addition of facilities associated with each node for easily and quickly constructing relationships between nodes as desired by the user so that their visual arrangement reflects these relationships, by selecting from a given node all the nodes to which it should be connected. Said facilities are initiated in the preferred embodiment by the user clicking on link 604 and similar associated with a given node 606 and similar. Link 604 is labeled “L” in the present example but may be indicated in any way desired, textural or graphic or otherwise. It will be apparent to one skilled in the art that link 604 is not confined to appearing within the node but may be displayed near the node, in a list of nodes, or in any way desired such that link 604 is associated with node 606, without leaving the scope of the present invention. A flowchart illustrating the function of link 604 is contained in Drawing 16. Link 611 is associated with node 610 in a way similar to that just disclosed for link 604 with its node 606, but initiates facilities for adding, editing, or deleting annotations to node 7610, said facilities being disclosed in Drawing 10 and its description.

Drawing 7 depicts diagram 700 of an exemplary embodiment of the present invention, displaying map 702, an alternate purely textural view of map 602 with the addition of facilities associated with each node for easily and quickly constructing relationships between nodes as desired by the user so that their visual arrangement reflects these relationships, by selecting from a given node all the nodes to which it is desired that it be connected. Said facilities are initiated in the preferred embodiment by the user clicking on hypertext or non-hypertext link 704 and similar associated with a given node 706 and similar. Link 704 is labeled “L” in the present example but may be indicated in any way desired, textural or graphic or otherwise. It will be apparent to one skilled in the art that link 704 may be displayed in a variety of ways to indicate its association with node 706 without leaving the scope of the present invention. Link 705 is associated with node 706 in a way similar to that just disclosed for link 704, and initiates facilities for adding, editing, or deleting annotations to node 706, said facilities being disclosed in Drawing 10 and its description.

Drawing 8 depicts diagram 800 of an exemplary embodiment of the present invention, displaying a user interface which allows the user to indicate nodes which are related for subsequent display with a connecting feature between the nodes, such as a line. It will be noticed that Drawing 8 resembles Drawing 4. The significant difference between the function represented by the two figures is that Drawing 8 is displayed in response to the user clicking the hypertext or non-hypertext label associated with a specific node, as illustrated in Drawing 6, item 604 and allows the establishment of relationships between said node and multiple other nodes, while Drawing 4 illustrates the definition of relationship between only two nodes.

In a preferred embodiment, the display 802 is presented to the user as a result of the user clicking hypertext or non-hypertext link 604, which is shown to be associated with node 606, labeled “Biomimicry”. The display 802 is subsequently presented to the user in order to allow the user to select all nodes that are to be connected visually and conceptually to node 606.

Drawing 9 depicts diagram 900 of an exemplary embodiment of the present invention, displaying map 902, an alternate map view presented herein in illustration of facilities associated with each node for easily and quickly constructing annotations to a node.

It will be noted that Drawing 9 is similar to Drawing 6, but it allows a focus of the present discussion on link 904, which link initiates functions for attaching annotations to nodes. Said functions are initiated in the preferred embodiment by the user clicking on hypertext or non-hypertext link 904 and similar associated with a given node 906 and similar. Link 904 is labeled “C” in the present example but may be indicated in any way desired, textural or graphic or otherwise. It will be apparent to one skilled in the art that link 904 is not confined to appearing within the node but may be displayed near the node, in a list of nodes, or in any way desired such that link 904 is associated with node 906, without leaving the scope of the present invention.

Drawing 10 depicts diagram 1000 of an exemplary embodiment of the present invention, disclosing facilities for attaching annotations to nodes. Such annotations might be the opinions and reflections of users on the content of the node, or machine-generated summaries of node content made easily visible to users for further comment and expansion. Dialog 1002 illustrates a display of annotations attached to node 610, also illustrated as node 706, said node being identified in dialog 1002 by label 1004. In the present example, the annotations are in the form of comments written by human users, said users identified by usernames such as 1006 and similar.

Dialog 1002 in a preferred embodiment is reached by clicking a link associated with a node, for example link 611, 705, 904, and similar.

Dialog 1002 allows multiple annotations to be displayed in one place while simultaneously indicating the node or nodes to which said annotations refer.

In addition, dialog 1002 allows annotations to nodes to be displayed while simultaneously displaying access to editing facilities for said annotations, the editing facilities being for altering or deleting said annotations or adding additional annotations.

According to the present invention, the editing facilities available to the user are automatically tailored according to access permissions determined by the identity of the viewing user. For example, it may be wished that a user be allowed to alter or delete only the annotations that that user had originally contributed, and not allowed to alter or delete an annotation which said user had not contributed. In the latter case buttons 1008, 1010 do not appear, while the user may still be allowed to contribute an additional annotation using button 1012. Such tailoring of editing facilities according to the access permissions of individual users is illustrated in annotation 1014. The present example illustrates a situation in which the viewing user is ‘jmiller’ 1006. Annotations which were not originally contributed by ‘jmiller’ 1006 have optionally differing permissions than those which ‘jmiller’ did contribute. For example, annotation 1014, being contributed by user ‘demo’ 1016, lacks buttons 1008 or 1010, in which case the present user ‘jmiller’ is not presented with or allowed to use buttons 1008 or 1010 for altering or deleting annotation 1014 because said annotation was contributed by a different user.

It will be recognized by one skilled in the art that the aforementioned example of annotation permissions is only one of many possible configurations and that the level of access to each annotation by users may be customized at will without stepping outside the claims of the present invention.

Drawing 11 depicts diagram 1100 of an exemplary embodiment of the present invention, disclosing facilities for annotating with reasons and opinions the relationships between nodes, not just the nodes themselves. In graph terms, this would be denoted by information associated with the “edges” or “vectors” between nodes, not just the nodes themselves. The present invention allows annotations to “vectors” or “edges” between nodes to be displayed in one convenient place while simultaneously giving access for reference to the nodes to which said annotations refer. Such annotations might be the opinions and reflections of users on the relationship between the nodes referred to, or rather, machine-generated summaries of node relationship made easily visible to users for further comment and expansion. Dialog 1102 illustrates a display of annotations attached to the edge between node 610 and 612, also illustrated as nodes 710 and 708, said nodes being identified in dialog 1102 by labels 1104 and 1105, respectively. In the present example, the annotations are in the form of comments written by human users, said users identified by usernames such as 1106 and similar.

Dialog 1102 in a preferred embodiment is reached by clicking a link associated with an edge, for example link 108, 512, 609, and similar.

Dialog 1102 allows multiple annotations to be displayed in one place while simultaneously indicating the nodes to which said annotations refer.

In addition, dialog 1102 allows annotations to nodes to be displayed while simultaneously displaying access to editing facilities for said annotations, for example facilities for altering or deleting said annotations or adding additional annotations.

According to the present invention, the editing facilities available to the user are automatically tailored according to access permissions determined by the identity of the viewing user. For example, it may be wished that a user be allowed to alter or delete only the annotations that that user had originally contributed, and not allowed to alter or delete an annotation which said user had not contributed. In the latter case buttons 1108, 1110 do not appear, while the user may still be allowed to contribute an additional annotation using button 1112. Such tailoring of editing facilities according to the access permissions of individual users is illustrated in annotation 1114. The present example illustrates a situation in which the viewing user is ‘jmiller’ 1106. Annotations which were not originally contributed by ‘jmiller’ 1106 have optionally differing permissions than those which ‘jmiller’ did contribute. For example, annotation 1114, being contributed by user ‘demo’ 1116, lacks buttons 1108 or 1110, in which case the present user ‘jmiller’ is not presented with or permitted to use buttons 1108 or 1110 for altering or deleting annotation 1114 because said annotation was contributed by a different user.

It will be recognized by one skilled in the art that the aforementioned example of annotation permissions is only one of many possible configurations and that the level of access to each annotation by users may be customized at will without stepping outside the claims of the present invention.

Drawing 12 depicts diagram 1200 of an exemplary embodiment of the present invention in which an intelligent link button 1204 is provided for installation on the user interface of a web browser 1202 for the purpose of automated extraction of information from existing Internet or Intranet web sites and transmittal to a target application. A high-level flowchart illustrating the application of link button 1204 within the present invention is given in Drawing 16, item 1618.

Link buttons similar in appearance to intelligent button 1204 are commonly used to change the Internet or Intranet web site being viewed to one to which the button is linked. That is, the link button presents an alternate URL to the web browser, which loads and displays the page corresponding to the alternate URL. For purposes of illustration, the alternate URL will be termed herein the “link target”.

In the present invention, however, the link button 1204, in addition to presenting an alternate URL to the web browser, also transmits to the “link target” ancillary information, in one example URL 1208 and Title 1206.

The link target's display page is returned, either to display 1202 or to a separate instance of a display, by a computer program. In most cases said program is one that transmits upon request the contents of the requested “target” web site. Such programs are commonly known to those skilled in the art as “web servers”. However, web servers may also employ other programs to perform specialized functions.

The present invention is one such specialized computer program 1214 for the purpose of generating and editing annotated maps for a single user or plurality of users, said program being one which in the course of presenting the link target page will also be able to use the ancillary information 1206, 1208 transmitted by intelligent button 1204.

In a preferred embodiment, such ancillary information is used to construct a node such as those displayed in Drawings 1,5,6,7, and 9. The node constructed in this manner thereafter functions as a link to the web site 1208 of which Content 1210 was being viewed at the time button 1204 was clicked.

A preferred method of accepting the ancillary information transmitted by link button 1204 is to fill by automated process address entry form 1304 or 1308 with URL 1208 and label entry form 1306 or 1310 with title 1206, relieving the user of having to type the information. Alternatively, said ancillary information could be directly supplied to the node generation function without previous display in form 1302.

In the present exemplary embodiment, the Javascript computer programming language is used to implement the function of intelligent button 1204 as follows: javascript:void(window.open(‘URL_of_knowledge_map_application?remoteTitle=’+esca pe(document.title)+‘&remoteURL=’+escape(document.location.href),‘Title_of_knowledg e_map_window’).focus( ))

It will be apparent to one skilled in the art that various capabilities of the Javascript language may be used to extract varying pieces of information from the displayed web site or the displaying web browser. One such piece of information is the current URL of the viewed page, which is extracted in the Javascript code by the reference to “document.location.hef”. Another such piece of information is the title of the viewed page, which is extracted in the Javascript code by the reference to “document.title”.

It will be apparent to one skilled in the art that the present disclosure of an intelligent button 1204 is not dependent upon the specific computer code used to implement its function, and a variety of computer code languages and alterations of the example computer code given herein are possible without leaving the scope of the present invention.

Drawing 13 depicts diagram 1300 of an exemplary embodiment of the present invention, disclosing facilities for intelligent form management. In the course of entering information for creation of a node or nodes, it becomes advantageous that empty fields of an entry form are automatically selected, or in the case where no empty fields are available, the oldest data is overwritten and the latest entered is preserved, freeing the user from tracking the order in which information is entered.

An example can be found in the use of the intelligent button 1204 disclosed in the discussion of Drawing 12. When the button 1204 is clicked by a user, the information 1206, 1208 necessary to complete portions of form 1302 is automatically transmitted to the relevant computer program, as disclosed in the discussion for Drawing 12. The relevant computer program in the present example is the invention disclosed herein for creating and editing of annotated maps, which program may return to the display mechanism viewed by the user (typically an Internet browser) the form data with the relevant information automatically entered into the appropriate form 1302 fields 1304 and 1306 collectively, or 1308 and 1310 collectively.

It is important that a mechanism or process be available to detect the presence of data previously entered into the form in order to prevent over-writing the old data with the new information received from intelligent button 1204.

It will be apparent to one skilled in the art that the aforementioned scenario is capable of alteration so that intelligent button 1204 sends information not to the computer program 1208 but directly without intermediary to the user interface displaying form 1302, in which case the need remains for detecting the presence of old data to be preserved.

In the event that all form fields relevant to the transmitted information are previously filled, it is additionally desirable that the form field into which information was first input, that is, the oldest data, is able to be detected by automated means, in which case it may be desirable to make an assumption that the oldest data is no longer relevant and may be over-written, optionally alerting the user before taking such action.

It is desired that the mechanism for detection of old data and selection of an appropriate field for information entry operate automatically and without explicit intervention by the user.

It will be apparent to one skilled in the art that many computer programs may benefit from an intelligent form management mechanism meeting the specifications disclosed herein, and that the present example of managing form data subsequent to clicking intelligent button 1204 is but one of many possible examples. The specific arrangement of form entry fields, their number, their names, their grouping, and their logical relationship to one another does not change the underlying mechanism disclosed in this discussion of Drawing 13.

In one exemplary embodiment an automated mechanism meeting the aforementioned requirements is effected by monitoring actions of the user and saving contents of the form entry fields when a specific action is detected. The saved content of the entry fields may then be recalled at a later time and detected as “old data”. One example is the removing of “focus” from an entry field. To those skilled in the art the term “focus” refers in the present context to the state of having a cursor present within an entry field. The loss of “focus”, that is the state in which the cursor is no longer present within said entry field, implying that user interest has turned away from said entry field, for example by performing an action in another part of the viewed display. Loss of “focus” may be detected by a function of the Javascript computer programming language called “on Blur”, which function executes a given sequence of commands in the event that focus is removed from a given feature of a web site.

It will be apparent to one skilled in the art that “on Blur” is one of many events that may be detected and made to effect the execution of the desired computer command sequence, and other events may be substituted without leaving the scope of the present invention.

It will also be apparent to those skilled in the art that the present invention is not dependent upon the Javascript computer programming language and that other languages may be used to effect the mechanism described without leaving the scope of the present invention.

The present invention may optionally but preferably give visual indication of its activities. The entry field or fields which have most recently had data saved by this mechanism may optionally be labeled descriptively so that the user is given visual confirmation of the fields selected by the present invention to receive data, that is, the field or fields containing the most recent entry. In the present example the descriptive label 1312 will alternate from being displayed in field grouping 1314 and 1316 as the present invention detects the oldest data present in the form fields and indicates correspondingly the newest data.

Drawing 14 depicts diagram 1400 of alternate exemplary embodiments of the present invention. Maximum flexibility can be obtained by making use of telecommunications links 1410a, 1410b and similar to connect the computers executing or storing the elements of a Map Controller 1402 with coupled database 1404, the User-Defined content 1403, the Link Targets 1406 which may be for example an Internet server computer, and User Interface 1408. The term “Map Controller” as used herein refers to the editing and management system for annotated maps disclosed in the present invention.

Map Controller 1402 or its coupled database 1404 store link address information referring to User-Defined Content 1403 which may be accessed via links provided by Map Controller 1404 to User Interface 1408. Said User-Defined Content 1403 may be entered in a preferred embodiment by users as depicted in Drawing 3, and typically but not exclusively includes information not previously available on existing servers such as Link Target 1406 or similar.

In one embodiment, User-Defined Content 1403 may be coupled to Map Controller 1402, for example by being stored in the file system of the computer which executes Map Controller 1402, or by being stored in the Map Controller Database 1404.

In another embodiment it may be desired for security or other reasons that User-Defined Content 1403 be contained on a computer separate from Map Controller 1402 and that Map Controller 1402 and its coupled database 1404 contain only addressable link information, for example URLs, referring to User-Defined Content 1403.

The service of collecting links to User-Defined Content 1403 allows any user of User Interface 1408 to make information available as a node in the map displayed on User Interface 1408 without requiring data writing access to Link Target 1406. The Map Controller Database 1404 may be attached directly to the Map Controller 1402 or accessible by telecommunications link.

Drawing 15 depicts diagram 1500 of alternate exemplary embodiments of the present invention. It will be apparent to one skilled in the art that without change to the present invention any permutation of all elements 1402-1410 inclusively of the present invention may reside and execute on a single computer, as depicted in Drawing 15, or on any number of separate computers connected by communications links. Other exemplary embodiments of the present invention can include a peer-to-peer or client-server environment.

Drawing 16 depicts diagram 1600 depicting a high-level flowchart of services provided by the present invention. Actions 1602 through 1614 produce results as shown, progressing from top to bottom in diagram 1600. Automated input 1602 could be illustrated by an automated scan of computer files 1620 or of Internet web sites 1624 with possible filtering of said files or sites for those relevant to a particular topic, for example by keyword proximity or other means. User input 1604 could be illustrated by said user entering location and descriptive information into a provided entry form, either manually 1622, or by clicking intelligent link button 1204 to extract said location and descriptive information from a user interface and automatically enter said information into appropriate entry form fields, optionally using smart form management facilities as disclosed in Drawing 13 and its associated description. Displayable information 1624 could be comprised of an Internet web site or other displayed data, of which the location and optional description of said displayable information is supplied to map generation facility 1628 for creation of said nodes and relationships between nodes.

Alternatively, the user may input original information using mechanism 1626, as disclosed in Drawing 3 and its accompanying discussion.

Drawing 16 also depicts facilities provided for the actions of deleting 1606 or editing 1608 of node data, said node data consisting of location and description of the entity to which the node refers or of the entity itself where applicable.

Drawing 16 also depicts facilities provided 1610 for connection of nodes, for example by simply indicating (1630) two nodes between which it is desired that a connection or relationship be defined, or in another example by selecting 1615 a first node or nodes to which arbitrary other nodes 1616 are to be connected or related.

Drawing 16 also depicts facilities 1612, 1634 for editing, deleting, and adding annotations to nodes and facilities 1614, 1634 for editing, deleting, and adding annotations to the relationships between nodes.

While various exemplary embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

1. An apparatus for generating and annotating maps comprising:
means for enabling a computer to query a user for an identifier capable of enabling later retrieval by computer of the data or function which the identifier represents, the identifier comprising a hypertext link address or a non-hypertext link address;
means for enabling a computer to store and retrieve from a database said identifiers;
means for enabling a computer to arrange said identifiers in arbitrary connected relationships;
means for enabling a computer to store and retrieve from a database said relationships;
means for enabling a computer to query a user for an annotation to be associated with said identifiers;
means for enabling a computer to store and retrieve from a database said annotations to said identifiers;
means for enabling a computer to query a user for an annotation to be associated with a relationship between two or more of said identifiers; and
means for enabling a computer to store and retrieve from a database said annotations to said relationships.

2. A computer system apparatus for gathering input for, editing, and accessing a map and its annotations comprising:
a) first computer;
b) a map controller, coupled to the first computer;
c) one or more databases coupled to said map controller; and
d) a User Interface coupled to said map controller, preferably by telecommunications link, the user interface capable of displaying a map which comprises;
i) nodes which represent information, the nodes having symbols representing links which comprise hypertext links or non-hypertext links to the information, or hypertext links or non-hypertext links to user comments on such information; and
ii) connections between two nodes, the connections representing a relationship between the two nodes, the connections having a related symbol representing a link which comprises a hypertext link or a non-hypertext link to a description of the relationship between the two nodes or a hypertext link or non-hypertext link to one or more user comments about the relationship between the two nodes.

3. The computer system apparatus according to claim 2, wherein said first computer, said map controller, one or more link target controllers and said user interface are coupled together by a network.

4. The computer system apparatus according to claim 2, wherein said map controller, one or more link targets and said user interface are embodied on a single computer system.

5. The computer system apparatus according to claim 2, wherein said map controller and said user interface may be embodied on a single computer system and coupled together with one or more link targets by a network.

6. The computer system apparatus according to claim 2, wherein said user interface and one or more link targets are embodied on a single computer system and coupled together with said map controller by a network.

7. The computer system apparatus according to claim 2 wherein information in said system is accessible from a graphic or textural representation of a node on the user interface.

8. The computer system apparatus according to claim 2 wherein information in said system is accessible from a graphic or textural representation of a relationship between nodes on the user interface.

9. The computer system apparatus according to claim 2 further comprising a system for displaying said user comments while providing access to the information with which said user comments are associated.

10. The computer system apparatus according to claim 2 wherein an intelligent button is used to extract desired information from a content displaying application or from the content displayed and to communicate the extracted information to a receiving computer program.

11. A computer implemented method for enabling the generation of a collection, referred to herein as a “map”, of entity identifiers, referred to herein as “nodes”; comprising the acts of:
capturing a first user input as annotations to connecting relationships between map nodes;
capturing a second user input of identifiers of arbitrary pre-existing information of any type or representation, such second user input to be used in generation of a map node and such identifier being a reference to an addressable entity, wherein the addressable entity may or may not be a hypertext link to an addressable Internet site;
capturing a third user input of user-generated information, to which a Map Controller assigns an identifier which is a reference to an addressable entity which may or may not be a hypertext link for subsequent access via a map interface, such third user input to be used in the generation of a map node.

12. The method according to claim 11, wherein the captured first, second or third user inputs are generated by a special automated process.

13. The method according to claim 11, wherein each of said entity identifiers can represent arbitrary data types or formats.

14. The method according to claim 13, wherein each entity can have arbitrary data types, formats or function.

15. A computer implemented method for managing form entry in an automated manner such that a user does not have to specify which entry fields are available for data entry, wherein data is automatically routed to empty fields and in the circumstance that all entry fields are filled with data, the entry fields containing oldest data are automatically selected for over-writing with new data.

16. A computer implemented method for displaying circular relationships in data by means of purely textural arrangement, wherein a sequence of relationship between nodes is indicated by indentation, decoration, or other means until terminated when the sequence arrives again at an initial node, and wherein the initial node is displayed to also be ending cause of the sequence.

17. A computer implemented method for accepting user input for creation of relationships between data identifiers wherein said identifiers are each associated with a symbol, said symbol providing a link, the link comprising a hypertext link or other non-hypertext linking information, which upon activation identifies a first data identifier associated with said link, and displays a representation of all data identifiers eligible for connection to the first data identifier, wherein the data identifiers to be connected can be connected one at a time or in multiple data identifiers at a time.

18. A computer program product embodied on a computer readable medium comprising computer program logic for generating and annotating maps comprising:
program code means for enabling a computer to query a user for an identifier capable of enabling later retrieval by computer of data or function which the identifier represents, the identifier comprising one or more hypertext link addresses or other non-hypertext linking information;
program code means for enabling a computer to store and retrieve from a database said identifiers;
program code means for enabling a computer to arrange said identifiers in arbitrary connected relationships;
program code means for enabling a computer to store and retrieve from a database said relationships;
program code means for enabling a computer to query a user for an annotation to be associated with the relationship between two or more of said identifiers;
program code means for enabling a computer to store and retrieve from a database said annotations to relationships;
program code means for enabling a computer to query a user for an annotation to be associated with one or more of said identifiers; and
program code means for enabling a computer to store and retrieve from a database said annotations to identifiers.

19. A computer implemented method for enabling the generation of a collection, referred to herein as a “map”, of entity identifiers, referred to herein as “nodes”;
comprising the acts of providing facilities for definition of relationship of any node to any other node or nodes;
providing facilities for attaching, editing, and deleting annotations to nodes or to the relationship between nodes;
providing facilities for displaying a map of such nodes and relationships to one or more users;
whereby a map of the nodes, relationships and annotations can be constructed and displayed by an individual user or jointly by a plurality of physically separated users.
